(19) United States
(12) Patent Application Publication
(10) Pub. No.: US 2010/0237299 A1
(43) Pub. Date: Sep. 23, 2010

(54) Thermal barrier coating

(75) Inventors: Masae Yamanaka, Tokyo (JP); Mitsuhiro Akuzawa, Tokyo (JP)

Correspondence Address: SMITH, GAMBRELL & RUSSELL, 1130 CONNECTICUT AVENUE, N.W., SUITE 1130, WASHINGTON, DC, 20036, US

(73) Assignee: Fuji Jukogyo Kabushiki Kaisha, Tokyo (JP)

(21) Appl. No.: 12/659,611

(22) Filed: Mar. 15, 2010

(30) Foreign Application Priority Data
Mar. 23, 2009 (JP) 2009-069807

(51) Int. Cl. F21V 9/04

(52) U.S. Cl. 252/587

(57) ABSTRACT

A thermal barrier coating includes an infrared-reflection layer that is formed by coating on a substrate and contains a white pigment having a sunlight-reflection characteristic; and an infrared-transmittance layer that is formed by coating on a surface of the infrared-reflection layer and contains a black organic pigment that transmits infrared light. Infrared light that has been transmitted through the infrared-transmittance layer and reached the infrared-reflection layer is reflected outward by the infrared-reflection layer through the infrared-transmittance layer. The black organic pigment contained in the infrared-reflection layer is perylene black that transmits infrared light with a higher transmittance than for visible light. The infrared-reflection layer has a reflectivity of 40 percent or more against infrared light.

### CROSS-REFERENCE TO RELATED APPLICATIONS

The present application claims priority from Japanese Patent Application No. 2009-069807 filed on Mar. 23, 2009, and is hereby incorporated by reference in its entirety.

### BACKGROUND OF THE INVENTION

1. Field of the Invention

The present invention relates to a thermal barrier coating that suppresses an increase in the temperature of a substrate on which the thermal barrier coating is provided by coating, the increase being caused by exposure of the substrate to sunlight.

2. Description of the Related Art

Outer panels of a vehicle body are coated to make the outer panels anticorrosive and aesthetic. The roofs and outer walls of buildings are coated to suppress degradation caused by corrosion and to make the coated members aesthetic.

For example, an outer panel of a vehicle body is coated in the following manner. The outer panel is subjected to a chemical conversion treatment to remove oils adhering to a surface of the outer panel and to form a chemical conversion coating. To make the outer panel anticorrosive, the outer panel is then coated by electrodeposition to form an undercoat on the surface of the chemical conversion coating. An intermediate coating is then formed on the surface of the undercoat by electrostatic coating. An overcoat is formed on the surface of the intermediate coating by electrostatic coating. The presence of the intermediate coating protects the undercoat from an external impact caused by, for example, a stone bouncing and hitting the vehicle and also enhances the adhesion between the overcoat and the undercoat. The overcoat is formed to make the surface of the outer panel aesthetic. The overcoat includes a color base layer and a clear layer that is transparent and is formed by coating on the color base layer. The color base layer is used to impart its color to the surface of a vehicle body.

To decrease the lightness of the color base layer so that the surface of the substrate is darkly colored so as to be black, dark blue, or the like, carbon black is generally used as a black pigment for a coating agent for forming the color base layer. Carbon black is advantageous in that it makes the surface of a substrate deep black, whereas it has a disadvantage in that it is likely to generate heat by absorption of infrared light. Accordingly, when an darkly colored vehicle having outer panels including color base layers containing carbon black as a black pigment is exposed to sunlight, the overcoats generate heat and the temperature of the vehicle readily increases, which applies a load to the air conditioner.

To overcome such a problem, in coating of steel panels of vehicle bodies, use of a pigment that does not absorb but does reflect infrared light for a coating agent for forming the color base layer of the overcoat has been studied. For example, Japanese Unexamined Patent Application Publication No. 2004-82120 discloses a thermal barrier coating agent containing not carbon black as a pigment but a metal oxide having an infrared-reflection characteristic as a black pigment. When such a thermal barrier coating agent is used for forming an overcoat on a steel panel of a vehicle body, the overcoat reflects infrared light. Japanese Unexamined Patent Application Publication No. 1993-293434 describes a thermal barrier coating agent made to have a thermal barrier property in the following manner. This thermal barrier coating agent does not contain carbon black as a pigment but contains a pigment mixture for decreasing the lightness of the resultant color base layer. This pigment mixture is obtained by additive color mixing in which two or more pigments among a red-based pigment, an orange-based pigment, a yellow pigment, a green pigment, a blue pigment, and a violet pigment that are less likely to absorb infrared light are combined. When an inorganic metal oxide having an infrared-reflection characteristic such as an iron oxide or a chromium oxide is used as a black pigment for forming a color base layer of an overcoat according to Japanese Unexamined Patent Application Publication No. 2004-82120, the following problems are caused. Since metal oxides have reddish brown or white turbidity, a deep black color is not provided and the color reproducibility is poor. Additionally, metal oxides have a large specific gravity and hence have poor pigment dispersibility upon stirring of materials of a coating agent in preparation of the coating agent. The poor dispersibility results in poor color stability during the coating operation. Since a pigment containing a chromium-based oxide contains a heavy metal, production of the pigment requires an extensive waste-treatment facility for preventing damage to the environment.

The thermal barrier coating agent described in Japanese Unexamined Patent Application Publication No. 5-293434 is used as follows. The lightness of the resultant color base layer of an overcoat is reduced by additive color mixing by which various color pigments can be prepared and the reflectivity against infrared light is enhanced with the overcoat. Thus, the absorption of solar heat is suppressed. According to Japanese Unexamined Patent Application Publication No. 5-293434, in addition to the color base layer, the intermediate coating and the undercoat are also formed with a pigment mixture obtained by additive color mixing in which a titanium oxide pigment is combined with two or more inorganic pigments among a red-based pigment, an orange-based pigment, a yellow pigment, a green pigment, a blue pigment, and a violet pigment.

However, the thermal barrier coating agent described in Japanese Unexamined Patent Application Publication No. 5-293434 is not applicable to the formation of the overcoat of an outer panel of a vehicle. This is because the thermal barrier coating agent is prepared such that the lightness of the resultant color base layer is reduced by mixing various colors. Thus, the resultant pigment mixture contains a red-based pigment and a blue pigment. Accordingly, the resultant color has turbidity and hence a deep-black coated surface is not obtained with the thermal barrier coating agent.

As in the conventional manner, when a color base layer of an overcoat for making a surface of an outer panel aesthetic is configured to reflect infrared light, the reflection of visible light is not avoided in the color base layer. For this reason, a decrease in the lightness of the color base layer is restricted and, in particular, a color base layer that is deep black is not obtained, which is problematic.

### SUMMARY OF THE INVENTION

An object of the present invention is to provide a thermal barrier coating that enhances the appearance of a substrate on which the thermal barrier coating is provided by coating and that suppresses an increase in the temperature of the substrate, the increase being caused by exposure of the substrate to sunlight.

A thermal barrier coating according to an embodiment of the present invention includes an infrared-reflection layer that is formed by coating on a substrate and contains a white pigment having a sunlight-reflection characteristic; and an infrared-transmittance layer that is formed by coating on a surface of the infrared-reflection layer and contains a black organic pigment that transmits infrared light, wherein infrared light that has been transmitted through the infrared-transmittance layer and reached the infrared-reflection layer is reflected outward by the infrared-reflection layer through the infrared-transmittance layer. In a thermal barrier coating according to an embodiment of the present invention, the black organic pigment may be a perylene pigment that transmits infrared light with a higher transmittance than for visible light.

In a thermal barrier coating according to an embodiment of the present invention, the infrared-reflection layer may further contain at least one of a color organic pigment less likely to absorb infrared light, a black organic pigment that transmits infrared light, and a yellow inorganic pigment having a solar-heat reflectivity of 60 percent or more.

In a thermal barrier coating according to an embodiment of the present invention, the infrared-reflection layer may have a reflectivity of 40 percent or more against infrared light and a lightness L value of 30 to 50. In a thermal barrier coating according to an embodiment of the present invention, the substrate is an outer panel of a vehicle body, the infrared-reflection layer is formed as an intermediate coating, and the infrared-transmittance layer is formed as a color base layer formed by coating on a surface of the intermediate coating.

According to an embodiment of the present invention, a thermal barrier coating includes an infrared-reflection layer that is formed by coating on the front surface of a substrate; and an infrared-transmittance layer that is formed by coating on the surface of the infrared-reflection layer. Since the infrared-transmittance layer is on the outer-surface side of the substrate, when the substrate is exposed to sunlight, the infrared-transmittance layer does not absorb infrared light of the sunlight. The infrared light that has been transmitted through the infrared-transmittance layer is reflected by the infrared-reflection layer. Since the infrared-transmittance layer absorbs and is less likely to reflect visible light in the sunlight, the infrared-transmittance layer is darkly colored in highly deep black, which enhances the appearance of the substrate. Since the infrared-reflection layer is configured to reflect infrared light that has reached through the infrared-transmittance layer, an increase in the temperature of the substrate can be suppressed.

When such a thermal barrier coating is applied to steel panels of vehicle bodies, an increase in the interior temperature of the vehicles can be suppressed, the increase being caused by infrared light in sunlight. When a thermal barrier coating according to an embodiment is formed on an outer panel of a vehicle body, the infrared-reflection layer is formed as the intermediate coating and the infrared-transmittance layer is formed as the color base layer of the overcoat.

When the infrared-reflection layer is made to have a reflectivity of 40 percent or more against infrared light in sunlight and a lightness L value of 30 to 50, the lightness difference between the infrared-reflection layer and the infrared-transmittance layer can be reduced. As a result, when a portion of the infrared-transmittance layer is removed, the deterioration of the appearance can be suppressed.

### BRIEF DESCRIPTION OF THE DRAWINGS

FIG. 1 is a schematic view of coatings formed on an outer panel (substrate) of a vehicle body;

FIG. 2 is a characteristics graph showing, in terms of measurement results of infrared transmittance, comparison between a perylene-based organic pigment and carbon black (black pearl color);

FIG. 3 is a characteristics graph showing the relationship between the wavelength of sunlight and the reflectivity of an infrared-reflection layer and an infrared-transmittance layer;

FIG. 4 is a characteristics graph showing test results relating to the relationship between reflectivity and temperature of an infrared-reflection layer;

FIG. 5 is an infrared-reflection characteristics graph showing the relationship between the infrared reflectivity and the lightness L value of infrared-reflection layers;

FIG. 6 is a characteristics graph showing comparison between a panel member including an infrared-reflection layer according to the present invention and a panel member of a comparative example in terms of temperature;

FIG. 7 is a characteristics graph showing temperature variations in roof portions in soaking tests; and

FIG. 8 is a characteristics graph showing temperature variations in interior average temperatures and at driver's face positions in soaking tests.

### DESCRIPTION OF THE PREFERRED EMBODIMENTS

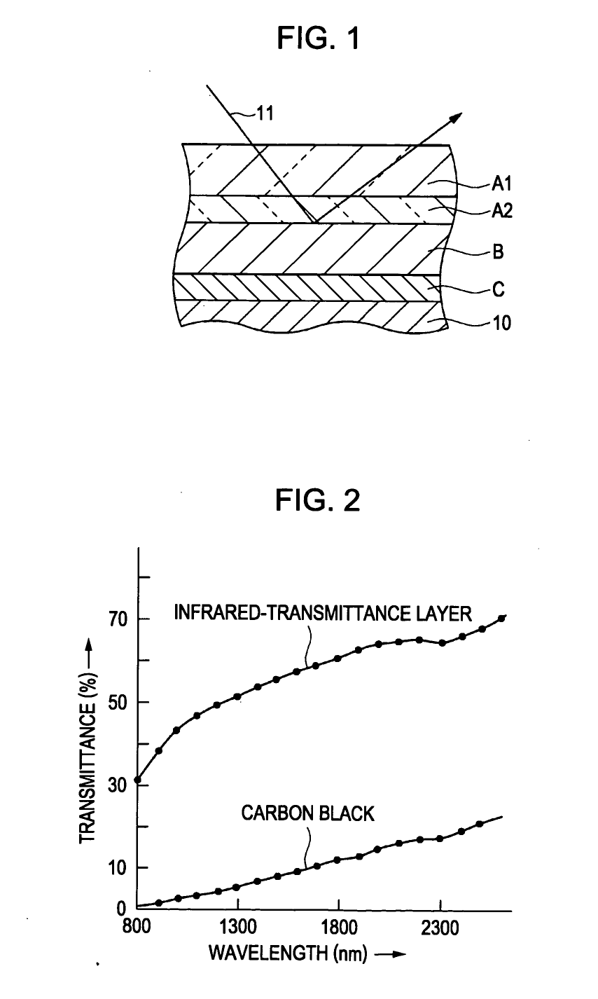

Hereinafter, embodiments according to the present invention will be described in detail with reference to the drawings. Referring to FIG. 1, for the purpose of making an outer panel 10 of a vehicle body anticorrosive, the outer panel 10 is coated by electrodeposition to form an undercoat layer C on the surface of the outer panel 10. An intermediate coating B is formed on the surface of the undercoat layer C by electrostatic coating. To make the surface of the outer panel 10 aesthetic, an overcoat is formed on the intermediate coating B by electrostatic coating. The overcoat includes a color base layer A2 and a clear layer A1 on the color base layer A2. The color of the surface of a vehicle body is based on the color of the color base layer A2.

A thermal barrier coating is formed on the outer panel 10 of a vehicle body as follows. An infrared-reflection layer is formed by coating as the intermediate coating B and an infrared-transmittance layer is formed by coating as the color base layer A2 of the overcoat. Thus, the thermal barrier coating layer includes the infrared-transmittance layer (A2) and the infrared-reflection layer (B).

The infrared-transmittance layer (A2) contains a black organic pigment that does not have an infrared-absorption characteristic and transmits infrared light. Examples of such a black organic pigment include perylene-based organic pigments.

FIG. 2 is a characteristics graph showing, in terms of measurement results of infrared transmittance, comparison between a coating containing a perylene-based organic pigment and a coating containing carbon black. As shown in FIG. 2, the coating containing a perylene-based organic pigment has higher transmittance in the infrared region than the coating containing carbon black as a pigment. Specifically, the measurement was conducted in the following manner. A laminated film in which a color base layer is formed of a coating agent containing carbon black as a pigment and a clear coating is formed thereon was used as a comparative example. Another laminated film in which a color base layer (serving as an infrared-transmittance layer according to the present invention) is formed of a coating agent containing a perylene-based organic pigment and a clear coating is formed thereon was used as an example. These laminated films were irradiated with rays having various wavelengths and the transmittance of the films was determined. As a result, as shown in FIG. 2, it has been demonstrated that, when an infrared-transmittance layer containing the black organic pigment is used as the color base layer A2 of an overcoat, the resultant infrared-transmittance characteristic is considerably high compared with the case where carbon black is used as a pigment. Since the black organic pigment has a low specific gravity than metal-oxide pigments, the black organic pigment exhibited good pigment dispersibility upon preparation of the coating agent. This coating agent exhibited coating-agent stability and coating processability that are equivalent to those of the comparative example.

The infrared-reflection layer (B), which is coated as the intermediate coating B on a steel plate of a vehicle body, contains a pigment containing titanium dioxide, the pigment serving as a white pigment having an excellent infrared-reflection characteristic. When the content of titanium dioxide is high, the resultant intermediate coating B has a high infrared reflectivity. However, when the infrared-reflection layer (B) is formed as the intermediate coating B having a high content of a white pigment, the coating process needs an extra step. The reason for this is as follows. Some inner panels of a vehicle body such as plate members under the engine hood are subjected to a coating process up to and including the intermediate coating step but not the overcoating step. In the case where the inner panels are subjected to the intermediate coating step so as to have black color, white mist having a high content of a white pigment reaches the inner panels under the engine hood upon the overcoating step of outer panels, which degrades the appearance of the inner panels. To overcome the disadvantage of this degraded appearance, the surfaces of the inner panels need to be subjected to correction coating, which increases the number of steps in the coating process. Additionally, a large lightness difference between an infrared-reflection layer (B) serving as the intermediate coating B and an infrared-transmittance layer (A2) serving as the color base layer A2 may cause the following disadvantage. When the color base layer A2 is damaged by an external impact caused by, for example, a stone bouncing and hitting the vehicle during driving, the intermediate coating B having a lightness considerably different from the lightness of the color base layer A2 is exposed, which degrades the appearance of the vehicle.

Accordingly, the infrared-reflection layer (B) is formed to contain a pigment mixture containing titanium oxide and at least one of a color organic pigment less likely to absorb infrared light, a black organic pigment transmitting infrared light, and a yellow inorganic pigment having a solar-heat reflectivity of 60 percent or more. In this case, the resultant infrared-reflection layer (B) has a low lightness and a sufficiently high reflectivity characteristic of an infrared-reflection layer without increasing the number of steps in the coating process.

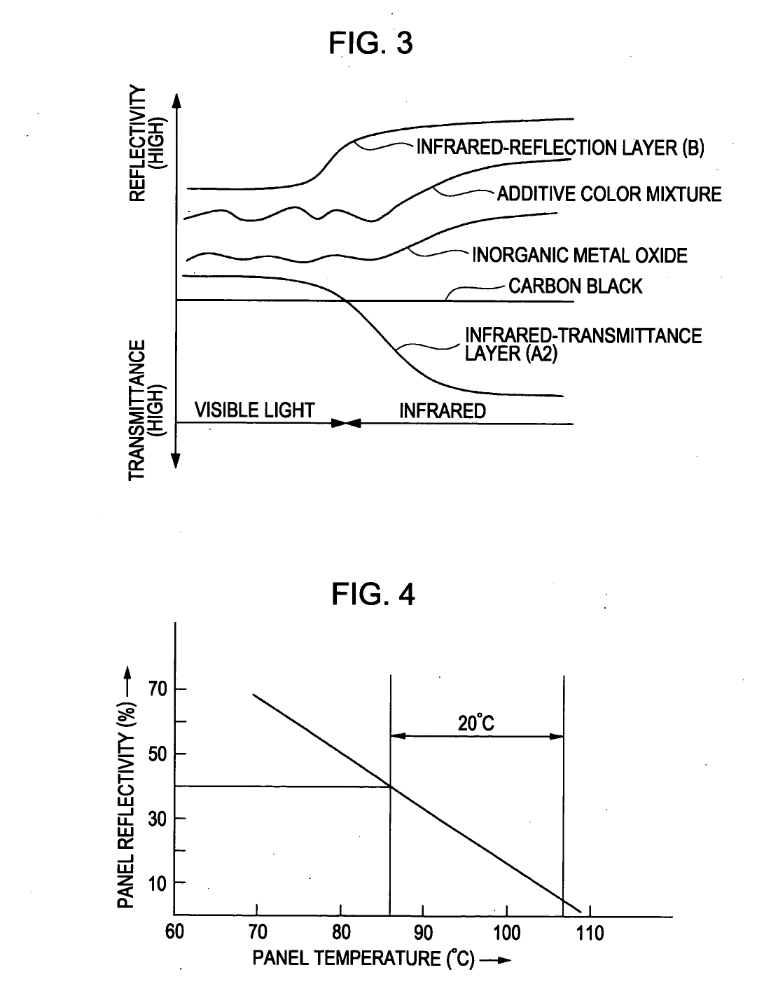

FIG. 3 is a characteristics graph showing the relationship between the wavelength of sunlight and the reflectivity of the infrared-reflection layer (B) and the infrared-transmittance layer (A2). The infrared-transmittance layer (A2) containing a perylene-based organic pigment transmits infrared light with a higher transmittance than for visible light. As shown in FIG. 3, when carbon black, which generates heat by exposure to infrared light, is used as a pigment, the sunlight reflectivity does not considerably change between the visible-light region and the infrared region. In the visible-light region, carbon black has a smaller reflectivity than the infrared-transmittance layer (A2).

As described above, formation of the color base layer with, as a black pigment, inorganic metal oxide having an infrared-reflection characteristic causes a problem. Metal oxides have reddish brown or white turbidity, which results in a higher reflectivity than carbon black even in the visible-light region. Accordingly, a deep black color is not provided with inorganic metal oxide. When the lightness of the color base layer of the overcoat is decreased by additive color mixing by which various color pigments can be prepared, the resultant sunlight-reflectivity is high compared with the case where metal oxide is used as a black pigment. This reflectivity is also higher than that of carbon black even in the visible-light region. Accordingly, a deep black color is not provided by additive color mixing. In FIG. 3, wavelike lines show that the reflectivity varies in accordance with the wavelength in the visible-light region.

The infrared-transmittance layer (A2) containing a perylene-based organic pigment has a lower visible-light reflectivity than the coating layer containing inorganic metal oxide having an infrared-reflection characteristic serving as a black pigment. Additionally, the visible-light reflectivity is lower than that of the coating layer containing a pigment made to have a low lightness by additive color mixing with a red-based pigment, an orange-based pigment, and the like. In summary, the infrared-transmittance layer (A2) containing a perylene-based organic pigment has a low reflectivity in the visible-light region, the reflectivity being close to that of carbon black. Accordingly, when the infrared-transmittance layer (A2) containing a perylene-based organic pigment is formed as the color base layer A2, a vehicle outer panel that is highly deep black, highly aesthetic, and darkly colored can be obtained.

In the present invention, a thermal barrier coating includes the infrared-reflection layer (B) and the infrared-transmittance layer (A2) that covers the surface of the infrared-reflection layer (B) and has a function different from that of the infrared-reflection layer (B). Specifically, the infrared-reflection layer (B) does not have a characteristic of generating heat upon exposure to infrared light. Referring to FIG. 1, when the outer panel 10 (substrate) on which the thermal barrier coating is formed is exposed to sunlight represented by arrow 11, infrared light in the sunlight passes through the infrared-transmittance layer (A2) having high infrared transmittance. The infrared light having passed through the infrared-transmittance layer (A2) is almost reflected by the infrared-reflection layer (B). In this way, when a vehicle body including an outer panel on which a thermal barrier coating according to the present invention is formed is exposed to sunlight, the effect of suppressing an increase in the interior temperature of the vehicle is sufficiently achieved. Additionally, since the infrared-transmittance layer (A2) transmits visible light with a transmittance equivalent to that of carbon black, a color base layer that is highly deep black and darkly colored can be obtained.

### EXAMPLES

Table 1 below shows the coating-agent composition and the pigment composition of coating agents serving as examples of coating agents for forming the infrared-transmittance layer (A2). Example (1) in Table 1 corresponds to a coating agent obtained by toning a coating solvent Magicron (trademark) FB800 manufactured by Kansai Paint Co., Ltd. to have a black pearl color. The pigment used in Example (1) was obtained by mixing, in the weight proportions shown in Table 1, black-based organic pigment A (17.7 weight percent) having an infrared-transmittance property, mica A and mica B serving as glittering agents, blue-based organic pigment A, yellow-based inorganic pigment A, and red-based organic pigment A.

Example (2) in Table 1 corresponds to a coating agent obtained by toning a water-based coating agent Aqua (trademark) BC-3 manufactured by BASF Coatings Japan Ltd. to have a black pearl color similar to that in Example (1). The pigment used in Example (2) was obtained by mixing, in the weight proportions shown in Table 1, black-based organic pigment B (47.3 weight percent) having an infrared-transmittance property, mica C and mica D serving as glittering agents, and green-based organic pigment A.

Table 2 below shows the coating-agent composition and the pigment composition of a coating agent serving as an example of a coating agent for forming the infrared-reflection layer (B). This coating agent was obtained by toning a coating solvent Rugerbake (trademark) FJX60 manufactured by Kansai Paint Co., Ltd. to have a lightness L value of 40 to 45. The pigment used was obtained by mixing, in the proportions shown in Table 2, white-based titanium oxide pigment A (42.0 weight percent wt), black-based organic pigment B, green-based organic pigment B, ocher-based inorganic pigment A, extender A, and extender B.

FIG. 4 is a characteristics graph showing test results relating to the relationship between infrared-reflectivity and temperature of the infrared-reflection layer (B) that is constituted by a single film. The reflectivity was measured in accordance with JISA5759. In the test, panel members in which the infrared-transmittance layers (A2) were formed on coating layers having different reflectivities were used. The front surfaces of the panel members were irradiated with infrared light emitted from infrared lamps and the temperatures of the back surfaces of the panel members were measured. As a result, it has been found that a panel member (test piece) having a reflectivity of 40% has the effect of suppressing an increase in the temperature by about 20° C. compared with a panel member having a reflectivity of 10 percent.

This test method was also used to evaluate panel members in terms of their effect of suppressing an increase in the temperature. These panel members were a panel member in which the color base layer was formed so as to contain metal oxide serving as a black pigment and a panel member in which the pigment of the color base layer was made to have a lower lightness by additive color mixing by which various color pigments can be prepared. As a result, the effect of suppressing an increase in the temperature was about 10° C. in both of the panel members.

As described above, when a substrate on which a thermal barrier coating including the infrared-reflection layer (B) and the infrared-transmittance layer (A2) is formed is exposed to sunlight, infrared light in the sunlight passes through the infrared-transmittance layer (A2). The infrared light having passed through the infrared-transmittance layer (A2) is reflected by the infrared-reflection layer (B). Accordingly, referring to FIG. 1, when a vehicle body including the outer panel 10 (substrate) on which a thermal barrier coating according to the present invention is formed is exposed to sunlight represented by arrow 11, infrared light in the sunlight passes through the infrared-transmittance layer (A2) serving as the color base layer A2. The infrared light having passed through the infrared-transmittance layer (A2) is reflected by the infrared-reflection layer (B) serving as the intermediate coating B. In this way, when the vehicle body is exposed to sunlight, the effect of suppressing an increase in the interior temperature of the vehicle is sufficiently achieved.

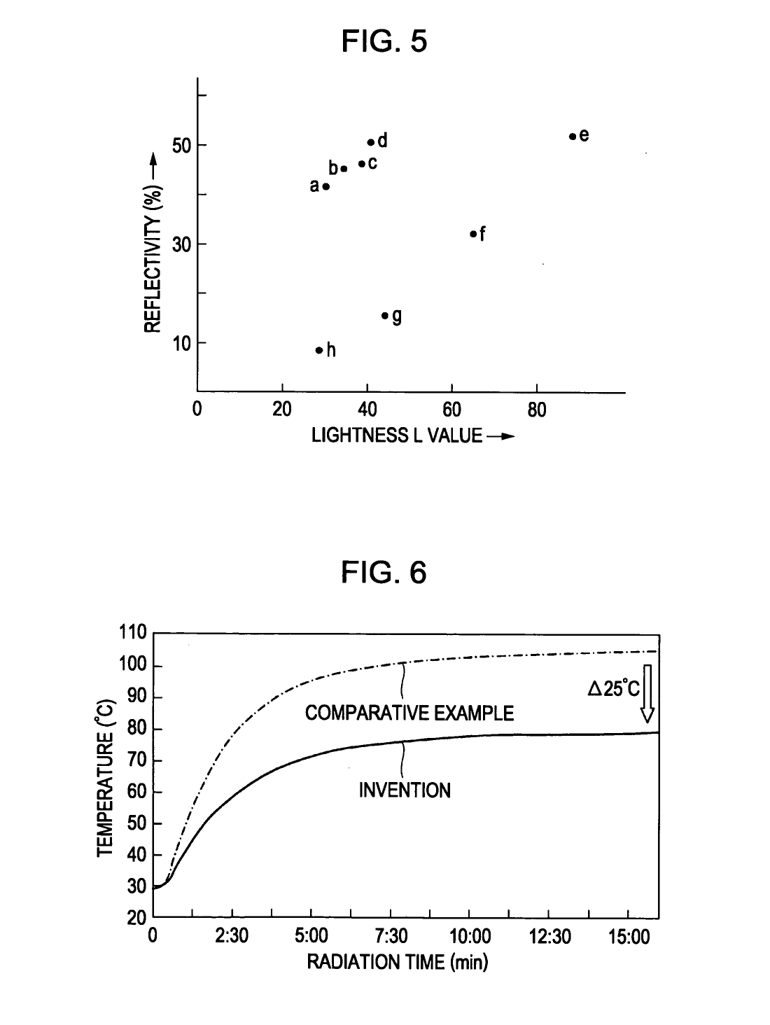

FIG. 5 is an infrared-reflection characteristics graph showing the relationship between the infrared reflectivity and the lightness L value of the infrared-reflection layer. FIG. 5 shows that there is a certain relationship between the infrared reflectivity and the lightness L value of the infrared-reflection layer. Specifically, the reflectivity of the infrared-reflection layer increases with an increase in the lightness of the infrared-reflection layer. Such a tendency is more clearly observed in conventional coating agents containing carbon black serving as a pigment. Reference characters e to h in FIG. 5 denote characteristics of conventional pigments and correspond to conventional examples (e) to (h) shown in Table 3 below as comparative examples.

The lightness of a coating agent can be decreased as the content of carbon black increases as in the conventional examples (e), (f), (g), to (h). However, at the same time, the reflectivity of the coating agent also sharply drops. When conventional coating agents are made to have a lightness L value of 50 or more, the lightness difference between the infrared-reflection layer (B) and the infrared-transmittance layer (A2) that is darkly colored becomes too large. In this case, when the color base layer A2 is damaged by an external impact caused by, for example, a stone bouncing and hitting the vehicle during driving, the intermediate coating B having a lightness considerably different from the lightness of the color base layer A2 is exposed, which degrades the appearance of the vehicle. Therefore, a thermal barrier coating for an outer panel of a vehicle body preferably has a lightness L value in the range of 30 to 50.

Furthermore, such a thermal barrier coating preferably has a lightness L value in the range of 30 to 45. Use of the following pigments for forming the infrared-reflection layer (B) according to the present invention allows achievement of the lightness L value of 50 or less and the reflectivity of 40 percent or more. Reference characters a to d in FIG. 5 denote Examples of the infrared-reflection layer (B) according to the present invention. In Examples a to d, coating agents containing, as pigments, a white pigment having a sunlight-reflection characteristic, an organic pigment less likely to absorb infrared light, a black organic pigment that transmits infrared light, and a yellow inorganic pigment having a solar-heat reflectivity of 60 percent or more were used. In Example d, a pigment mixture obtained by mixing these pigments in the weight proportions shown in Table 2 was used.

FIG. 6 is a characteristics graph showing comparison between a panel member (FIG. 1) in which an infrared-transmittance layer (A2) is formed on an infrared-reflection layer (B) according to the present invention and a panel member of a comparative example in terms of temperature. Specifically, the temperatures of the panel members were measured with an instrument similar to that used in the test of measuring the relationship between the infrared reflectivity and the temperature of panel members shown in FIG. 4. For the comparative example, a conventional black-pearl coating agent containing carbon black as a pigment was used. For the present invention, the coating agent of Example in Table 2 was used for forming the infrared-reflection layer (B) and the coating agent of Example (2) in Table 1 was used for forming the infrared-transmittance layer (A2). As a result, the maximum temperature of the comparative example was 104° C., whereas, under the same conditions, the maximum temperature of the panel according to the present invention in which the infrared-transmittance layer (A2) was formed on the infrared-reflection layer (B) was 79° C. In summary, according to the present invention, the effect of reducing the temperature by 25° C. was achieved.

Comparison tests were then conducted with actual vehicles on which coating agents were applied. As in the tests conducted in FIG. 6, a thermal barrier coating according to the present invention was formed and, for a comparative example, the conventional black-pearl coating agent containing carbon black as a pigment was used.

In the comparison tests, the following four tests were conducted in an environmental test lab. The first test was a midsummer soaking (left under a scorching sun) test. In the first test, an increase in the interior temperature of the vehicles was measured while a light wind was blown toward the front side of the vehicles. The second test was a maximum cooling test. After the vehicles were subjected to soaking for a period of time, the interiors of the vehicles were cooled using their maximum cooling capability and a decrease in the interior temperature of the vehicles was measured. The third test was a cooling down test with the auto-air-conditioner mode. After the vehicles were subjected to soaking for a period of time, the time over which the interior temperatures of the vehicles reached a certain temperature under the auto mode of the air conditioners was measured. The fourth test was a fuel-consumption test. The fuel consumption of the vehicles was measured while the vehicles were driven under a certain driving mode.

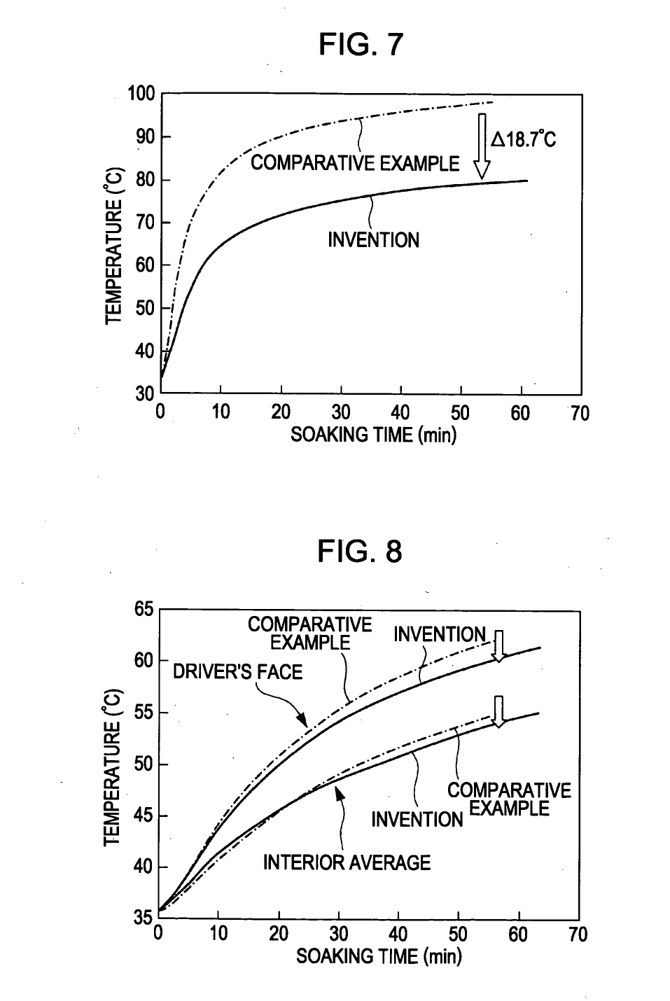

FIG. 7 is a characteristics graph showing temperature variations in roof portions in the soaking tests. FIG. 8 is a characteristics graph showing temperature variations in interior average temperatures and at the driver's face positions in the soaking tests. As shown in FIGS. 7 and 8, according to the present invention, the effect of reducing temperature by 18.7° C. was achieved at the roof portion and the temperature at the position around the driver's head and the interior temperature of the vehicle were also reduced. The effect of reducing temperature in the tests was lower than that (25° C.) in the test using a panel member (test piece). This is probably because, in the soaking tests, a light wind was blown toward the front side of the vehicles in the environmental test lab.

In the second test, which was a maximum cooling test, the interior temperature was reduced by 0.7° C. according to the present invention compared with the comparative example and the cooling effectiveness of the air conditioner was enhanced. In the third test, which was a cooling down test, the time over which the interior temperature reached 25° C. was reduced by 35% and it was demonstrated that the interior was cooled faster using the present invention. In the fourth test, which was a fuel-consumption test, it was demonstrated that the fuel consumption was enhanced by 1.1 percent in the suburban driving mode.

The present invention is not restricted to the above-described embodiments and variations and modifications can be effected within the spirit and scope of the invention. For example, although the infrared-transmittance layer and the infrared-reflection layer are formed as a coating on an outer panel of a vehicle body in the above-described embodiments, a thermal barrier coating according to the present invention is also applicable to the roof or an outer wall of a building for the purpose of suppressing an increase in the temperature of such a substrate, the increase being caused by exposure to sunlight.

TABLE 1
INFRARED-TRANSMITTANCE LAYER

| | | EXAMPLE (1) | EXAMPLE (2) |
|---|---|---|---|
| TYPE OF COATING AGENT | | COATING | WATER-BASED |
| | | SOLVENT | COATING AGENT |
| MANUFACTURER OF COATING AGENT | | Kansai Paint Co., | BASF Coatings Japan |
| | | Ltd. | Ltd. |
| TRADENAME OF COATING AGENT | | Magicron FB800 | Aqua BC-3 |
| COLOR | | BLACK PEARL | BLACK PEARL |
| COATING-AGENT | TYPE OF RESIN | ACRYLIC/ | POLYURETHANE/ |
| COMPOSITION | | POLYESTER/ | POLYESTER/ |
| | | MELAMINE | MELAMINE |
| | RESIN | 38.4 wt % | 21.9 wt % |
| | PIGMENT | 4.1 wt % | 2.1 wt % |
| | SOLVENT | 52.6 wt % | 9 wt % |
| | ADDITIVE | 4.9 wt % | 2.84 wt % |
| | DEIONIZED WATER | — | 64.2 wt % |
| PIGMENT | MICA GLITTERING | 9.0 wt % | — |
| COMPOSITION | AGENT A | | |
| MIXING | MICA GLITTERING | 1.9 wt % | — |
| PROPORTIONS | AGENT B | | |
| | BLUE-BASED ORGANIC | 26.5 wt % | — |
| | PIGMENT A | | |
| | YELLOW-BASED | 22.8 wt % | — |
| | INORGANIC PIGMENT A | | |
| | RED-BASED ORGANIC | 22.1 wt % | — |
| | PIGMENT A | | |
| | BLACK-BASED | 17.7 wt % | — |
| | ORGANIC PIGMENT A | | |
| | (INFRARED- | | |
| | TRANSMITTANCE | | |
| | PIGMENT) | | |
| | MICA GLITTERING | — | 5.7 wt % |
| | AGENT C | | |
| | MICA GLITTERING | — | 4.4 wt % |
| | AGENT D | | |
| | BLACK-BASED | — | 47.3 wt % |
| | ORGANIC PIGMENT B | | |
| | (INFRARED- | | |
| | TRANSMITTANCE | | |
| | PIGMENT) | | |
| | GREEN-BASED | — | 42.6 wt % |
| | ORGANIC PIGMENT A | | |

TABLE 2
INFRARED-REFLECTION LAYER

| | | EXAMPLE |
|---|---|---|
| TYPE OF COATING AGENT | | COATING SOLVENT |
| MANUFACTURER OF COATING AGENT | | Kansai Paint Co., Ltd. |
| TRADENAME OF COATING AGENT | | Rugerbake FJX60 |
| COLOR | | DARK GRAY |
| COATING-AGENT | TYPE OF RESIN | POLYESTER/EPOXY/ |
| COMPOSITION | | MELAMINE |
| | RESIN | 39.3 wt % |
| | PIGMENT | 21.3 wt % |
| | SOLVENT | 38.5 wt % |
| | ADDITIVE | 0.4 wt % |
| | OTHER COMPONENTS | 0.5 wt % |
| PIGMENT | WHITE-BASED TITANIUM | 42.0 wt % |
| COMPOSITION | OXIDE PIGMENT A | |
| MIXING PROPORTIONS | BLACK-BASED ORGANIC | 3.4 wt % |
| | PIGMENT B | |
| | (INFRARED-TRANSMITTANCE | |
| | PIGMENT) | |
| | GREEN-BASED ORGANIC | 2.6 wt % |
| | PIGMENT B | |
| | OCHER-BASED INORGANIC | 5.0 wt % |
| | PIGMENT A | |
| | EXTENDER A | 42.0 wt % |
| | EXTENDER B | 5.0 wt % |

TABLE 3
CONVENTIONAL COATING AGENTS (MASS-PRODUCED COATING AGENTS)

| | | CONVENTIONAL | CONVENTIONAL | CONVENTIONAL | CONVENTIONAL |
|---|---|---|---|---|---|
| | | EXAMPLE (e) | EXAMPLE (f) | EXAMPLE (g) | EXAMPLE (h) |
| TYPE OF COATING AGENT | | COATING SOLVENT | <-- | <-- | <-- |
| MANUFACTURER OF COATING AGENT | | Kansai Paint Co., Ltd. | <-- | <-- | <-- |
| TRADENAME OF COATING AGENT | | Rugerbake FJX60 | <-- | <-- | <-- |
| COLOR | | WHITE | LIGHT GRAY | DARK GRAY | BLACK |
| COATING- | TYPE OF RESIN | POLYESTER/ | <-- | <-- | <-- |
| AGENT | | EPOXY/MELAMINE | | | |
| COMPOSITION | RESIN | 34.2 wt % | 34.1 wt % | 33.9 wt % | 36.6 wt % |
| | PIGMENT | 30.8 wt % | 30.8 wt % | 30.6 wt % | 25.7 wt % |
| | SOLVENT | 34.2 wt % | 34.2 wt % | 34.7 wt % | 36.8 wt % |
| | ADDITIVE | 0.3 wt % | 0.3 wt % | 0.3 wt % | 0.4 wt % |
| | OTHER COMPONENTS | 0.5 wt % | 0.5 wt % | 0.5 wt % | 0.5 wt % |
| PIGMENT | WHITE-BASED TITANIUM | 96.8 wt % | 66.0 wt % | 65.3 wt % | 19.1 wt % |
| COMPOSITION | OXIDE PIGMENT A | | | | |
| MIXING | CARBON BLACK A | — | 0.7 wt % | 1.3 wt % | 3.1 wt % |
| PROPORTIONS | EXTENDER A | — | 30.0 wt % | 30.1 wt % | 73.5 wt % |
| | EXTENDER B | 3.2 wt % | 3.3 wt % | 3.3 wt % | 4.3 wt % |

1. A thermal barrier coating comprising:
an infrared-reflection layer that is formed by coating on a substrate and contains a white pigment having a sunlight-reflection characteristic; and
an infrared-transmittance layer that is formed by coating on a surface of the infrared-reflection layer and contains a black organic pigment that transmits infrared light,
wherein infrared light that has been transmitted through the infrared-transmittance layer and reached the infrared-reflection layer is reflected outward by the infrared-reflection layer through the infrared-transmittance layer.

2. The thermal barrier coating according to claim 1, wherein the black organic pigment is a perylene pigment that transmits infrared light with a higher transmittance than for visible light.

3. The thermal barrier coating according to claim 1, wherein the infrared-reflection layer further contains at least one of a color organic pigment less likely to absorb infrared light, a black organic pigment that transmits infrared light, and a yellow inorganic pigment having a solar-heat reflectivity of 60 percent or more.

4. The thermal barrier coating according to claim 1, wherein the infrared-reflection layer contains the white pigment, a color organic pigment less likely to absorb infrared light, a black organic pigment that transmits infrared light, and a yellow inorganic pigment having a solar-heat reflectivity of 60 percent or more.

5. The thermal barrier coating according to claim 1, wherein the infrared-reflection layer has a reflectivity of 40 percent or more against infrared light in sunlight and a lightness L value of 30 to 50.

6. The thermal barrier coating according to claim 1, wherein the substrate is an outer panel of a vehicle body, the infrared-reflection layer is formed as an intermediate coating, and the infrared-transmittance layer is formed as a color base layer formed by coating on a surface of the intermediate coating.
